(19) United States
(12) Patent Application Publication
(10) Pub. No.: US 2026/0129092 A1
(43) Pub. Date: May 7, 2026

(54) Methods and Apparatus for Data Sharing for Services

(71) Applicant: Telefonaktiebolaget LM Ericsson (publ), Stockholm (SE)

(72) Inventor: Brian Gunning, Athlone, County Westmeath (IE)

(21) Appl. No.: 19/118,185

(22) PCT Filed: Oct. 4, 2022
(86) PCT No.: PCT/EP2022/077593

§ 371 Date: Apr. 3, 2025

(51) Int. Cl. H04L 67/1095; G06F 9/445

(52) U.S. Cl. CPC H04L 67/1095; G06F 9/44526

(57) ABSTRACT

In an example there is provided a method of data sharing for services on an operating platform (105) for a distributed network. The method comprises monitoring for a first operating platform instruction corresponding to installation of a first service (140 #1) with a configuration resource (130 #1) the first service to be associated with a first datastore (125-1 #1). Using the configuration resource (130 #1) of the first service and a configuration resource (130 #2) of a second service (140 #2) to determine that the first service can share data in a second datastore (125-1 #2) associated with the second service. In response to determining that the first service can share data in the second datastore associated with the second service, configuring the first datastore (125-1 #1) and the second datastore (125-1 #2) to share data using first and second configuration resources (130 #1, 130 #2).

### TECHNICAL FIELD

Embodiments disclosed herein relate to methods and apparatus for sharing data for services deployed on an operating platform for a distributed network.

### BACKGROUND

The third-generation partnership (3GPP) is currently working on standardization of Fifth Generation New Radio (5G NR) technologies. These include improvement of the air interface in the radio access network (RAN) between terminal devices and RAN nodes such as 5G Node B (5G NB), together with mobile edge computing which enables cloud computing capabilities at the edge of the RAN in order to enhance performance. Improvements in communications networks such as 3GPP 5G include increased connectivity, speed and bandwidth provision. Such communications networks facilitate the use of Internet of Things (IoT) devices and well as making available greater network resources to user devices.

The use of more flexible network resource infrastructure and operating systems such as Kubernetes allows for the provision of microservices by third parties using the underlying network resources; so called infrastructure as a service. Kubernetes defines containers or a lowest unit of microservice comprising applications, libraries and their dependencies. Each container is deployed and run on a node but may interact with containers on other nodes using Kubernetes signaling.

This architecture and organization allows greater flexibility, including providing additional opportunities for revenue by infrastructure providers as well as a greater diversity of services for users. For example, users with limited equipment may become microservice providers offers very specialized services such as providing security footage for a specific building, weather conditions for a neighborhood, drone tracking in a very small local airspace, astronomical observatory services using a small telescope and so on. However, deploying and managing these microservices on the network infrastructure can be complex to implement.

### SUMMARY

According to certain embodiments described herein there is provided a method of data sharing for services on an operating platform for a distributed network. The method comprises monitoring for a first operating platform instruction corresponding to installation of a first service with a configuration resource the first service to be associated with a first datastore, using the configuration resource of the first service and a configuration resource of a second service to determine that the first service can share data in a second datastore associated with the second service, and in response to determining that the first service can share data in the second datastore associated with the second service, configuring the first datastore and the second datastore to share data using first and second configuration resources.

This allows the deployment and configuration of datastore sharing to be more automated, easing microservice provider workload and network knowledge requirements and thereby encouraging the deployment of microservices. This also advantageously includes the ability to dynamically synchronize and share stateful data between independent datastores without any imposition on the datastore itself.

According to certain embodiments there is provided a network node for data sharing for services on an operating platform. The network node comprises a processor and memory and configured to monitor for a first operating platform instruction corresponding to installation of a first service with a configuration resource the first service to be associated with a first datastore, use the configuration resource of the first service and a configuration resource of a second service to determine that the first service can share data in a second datastore associated with the second service, and to configure the first datastore and the second datastore to share data using first and second configuration resources in response to a determination that the first service can share data in the second datastore associated with the second service.

Certain embodiments also provide corresponding computer programs and computer program products.

### BRIEF DESCRIPTION OF DRAWINGS

For a better understanding of the embodiments of the present disclosure, and to show how it may be put into effect, reference will now be made, by way of example only, to the accompanying drawings, in which:

FIG. 1 is a schematic diagram illustrating a plurality of services and datastores on a Kubernetes operating platform according to an example;

FIG. 2 is a flow diagram illustrating a method of configuring shared data for a service according to an example;

FIG. 3 is a messaging diagram illustrating Kubernetes communications configuring shared data for a service according to an example;

FIG. 4 is a schematic diagram illustrating Kubernetes pods operating on network nodes according to an example;

FIG. 5 is a messaging diagram illustrating Kubernetes communications configuring shared data for a service according to an example; and

FIG. 6 is a flow diagram illustrating a method of configuring shared data for a service according to an example.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Embodiments described herein relate to methods and apparatuses to allow data sharing by services in an operating platform for a distributed network. This can be configured easily and incrementally without modification to existing deployment. In an example stateful data between Kubernetes deployed services can be shared without having to share the service itself. This maintains the microservice principle of a single database or datastore per service to keep failure domains small whilst enabling simple deployment and configuration of services that share (some) data.

Kubernetes is an open source platform for managing containerised workload and services and is rapidly growing in usage for cloud computing applications. Its architecture is based on master-nodes separation, where a master acts as the primary control plane for Kubernetes while nodes are the “workers” of a Kubernetes cluster, running a minimal agent that manages the node itself and executing workloads as designed by the master. Kubernetes is a container based approach to computing resources or processes allowing these to be distributed across multiple hardware nodes in an efficient manner. Kubernetes defines pods which are groupings of containers or computing functions guaranteed to be on the same host machine but which may share some resources, such as the host's operating system, with other pods on the same host machine. The pods are decoupled from the underlying hardware architecture allowing them to be portable across a cloud computing node cluster controlled by the Kubernetes platform. Containers within a pod communicate with each other using a localhost mechanism and Kubernetes allocates a single IP address per pod to allow communication between pods and remote hosts, terminals or other external resources or clients.

Embodiments described herein provide for the automated deployment of services sharing data with another service. For example, a helicopter tracking service may share data with a more general aircraft tracking service. According to Kubernetes organisation each services considers its own data separately and independently of other services and so configuring data sharing between services has previously required manual configuration which is time consuming and requires significant expert input.

The term network entity used herein refers to any functional or computing process, software and/or hardware that is capable of performing the various network functions described. This may be implemented as a network element, a network node, software which may be tied to particular hardware or which may be portable across different hardware. This software may correspond to container-based groups of computing functions such as a Kubernetes pod which may be an example of a network entity. However, the term network entity is not limited to a Kubernetes pod or other container-based entities, nor to specific hardware.

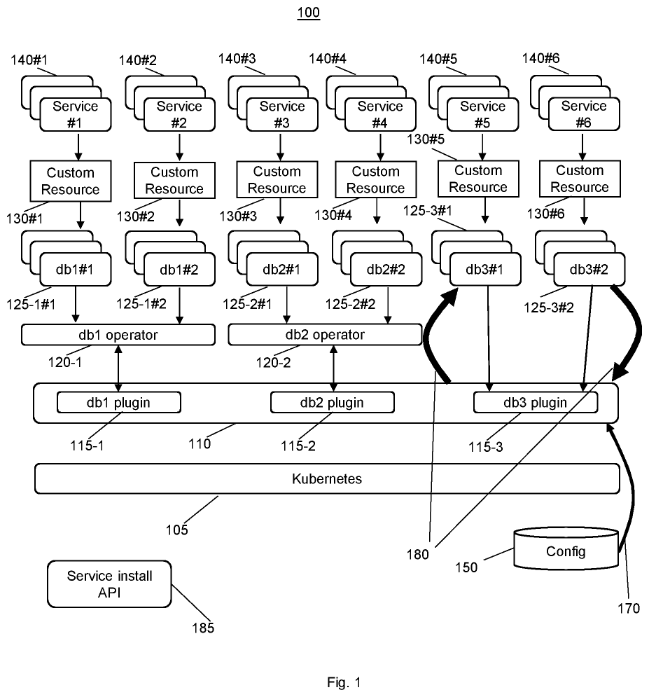

FIG. 1 illustrates a a schematic diagram illustrating a plurality of services and datastores on a Kubernetes operating platform according to an example. A number of services 140 #1-140 #6 may be served by a Kubernetes operating platform 105 running on one or more network nodes of a distributed network such as a 5G communications network. The services may be provided by vendors utilizing the underlying network and may provide a wide range of functionality that may be tailored to small numbers of potential users.

Each service 140 #1-140 #6 may use data stored in one or more respective datastores 125-1 #1-125-3 #2 which may be managed using Kubernetes or non-Kubernetes signaling. The datastores may be of different types and/or on different nodes and some of these may be managed by respective operators 120-1-120-2 which may communicate with the underlying Kubernetes operating platform 105 and/or the respective services 140 #1-140 #6.

The embodiment employs a synchronisation layer 110 between deployed services and the operating platform 105 to assist with configuration of the services and their respective datastores. The synchronisation layer may be implemented as controllers installed on respective nodes as described below. A new service may be installed by a service provider using a predetermined operating platform instruction, such as a bespoke CRUD event for a Kubernetes operating platform. The synchronisation layer 110 intercepts such commands and identifies a configuration resource or custom resource 130 #1-130 #6 associated with the new service 140 #1-140 #6. This may indicate a location or identifier in a config database 170 containing the associated configuration resource data 130 #1.

A service install API 185 may be provided with the operating system 105 to allow vendors to install services and point to associated custom resources. Custom resources can themselves by added or updated using this API.

Each custom resource is associated with configuration resource or custom resource data for the service to be deployed, including the type of datastore required and the type and range of data that the service will utilise. For example, a helicopter tracking service may include aircraft registration, aircraft type, date/time, location (longitude, latitude), speed, altitude and other parameters. The custom resource data may point to another datastore and/or service for sharing data, such as an aircraft tracking service provided by the same vendor. This may be achieved using a service name or other identifier. Alternatively, data sharing between services may be achieved by creating a “data group” where all datastores in the group will have their data synced. In another example, the custom resource data may include mandatory and optional data types so that the synchronisation layer may service for other services with which the new service may share data.

In other examples, services may share topology information about a shared network they are managing but not share any data local to the services; for example service 1 may be managing nodes, 1,2,3 in the topology and service 2 is managing 4,5,6. The overall topology (nodes 1-6) and any changes to it are shared but data unique to 1,2,3 for example will not be shared with service 2. In other examples, initial configuration data may be shared across services but any tuning data that changes over time and unique to one of the services remains unshared. In other examples, services may be configured to share just user authentication/authorization information and not share anything else. This is all configuration using configuration data in the custom resource and custom resource in the config store 170.

The synchronisation layer 110 may forward standard operating platform instructions and parameters to the operating platform 105 to enable this to configure the service and respective datastore within the operating platform environment. This includes syncing data between the involved datastores. Actual implementation may vary considerably. In some examples plugins are used and in other examples the synchronisation layer 110 may be configured to implement this directly by readying data from one datastore and sending to another. Some plugins may have command line style tools designed for manual database administration rather than auto date exposition/syncing. In some cases, these tools may be harnessed to send/expose the data. In other cases, a more fully enabled plugin may be used to automate this functionality.

Once deployed and configured, operation of the service and its respective datastore is performed using the usual Kubernetes commands, parameters and data processing. The synchronisation layer 110 therefore operates in tandem with the newly defined custom resources simply to configure new services to share data in the operating platform environment in an automated manner.

The synchronisation layer 110 may however be configured to manage sharing of data between configured datastores. This may be implemented by directly instructing the datastores and/or datastore operators or by instructing Kubernetes to perform data sharing functions. Alternatively, the layer 110 may configure Kubernetes 105 or the datastore operators to perform data sharing periodically.

In order to configure a new service to share data, the synchronisation layer 110 may ensure there are no schema conflicts, for example determining that the requested sharing datastores have the same data types, compatibility of CPU and RAM resources, network latency as well as sufficient compute and network resources to ensure synching is possible and efficient. This may be useful where both the datastores already contain data before setting up sharing or synchronising of some of that data.

The synchronisation layer 110 may install plugins 115-1-115-3 for greater flexibility to allow for communication with different types of services 140 #1-140 #6, datastores 125-3 #1-125-3 #2, datastore operators 120-1, 120-2, the configuration database 150 and even different versions of the operating platform 105.

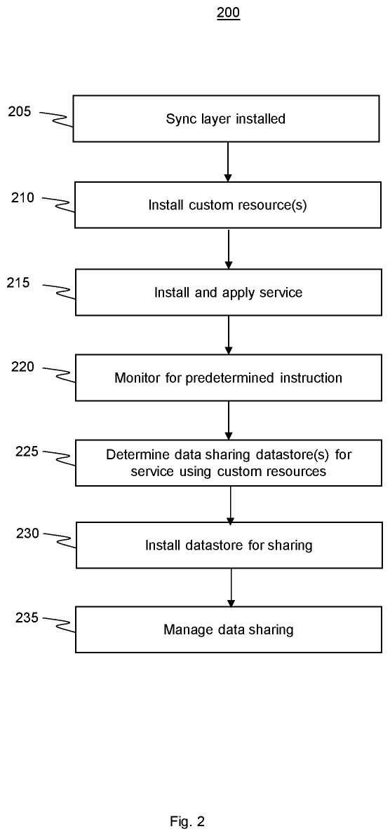

FIG. 2 illustrates a method of configuring and managing shared data between services. This method 200 may be implemented by a network operated using an operating platform such as Kubernetes. Reference is also made to the network architecture of FIG. 1.

At 205, a synchronisation layer 110 is installed on the operating platform 105. This may be an implementation of a Kubernetes controller acting as a client for a Kubernetes API and a controller for the datastores it is managing using Kubernetes operators.

At 210, a custom resource associated with a service is installed. This may be installed in Kubernetes and will reference configuration data for the service (and its datastore) which is stored in a configuration database 150. The custom resource may be installed by a service provider using a service install API integrated with the operating platform 105.

At 215, a service is installed and applied. This can be done by a service provider using the service install API or any other suitable method. In an example the service may be installed and applied in Kubernetes using a Kubernetes tool such as “kubectl” or Helm. Once the service is installed, it is applied or executed and is arranged to send a first operating platform instruction such as a bespoke Kubernetes instruction or CRUD event to the operating or Kubernetes platform. This instruction includes an identifier for the service and/or datastore and is not recognised by the Kubernetes operating platform 105 and so is ignored.

At 220, the method monitors for this bespoke Kubernetes instruction using the installed synchronisation layer 110. At 225, the synchronisation layer uses identifiers in the instruction to find a custom resource for the new service. The custom resource may include instructions and/or parameters for a datastore for use with the new service.

At 230, the datastore is installed, for example by interfacing with the underlying operating platform directly using an appropriate plugin. In an example, for a new service with a new type of datastore, the datastore is simply installed and manged on behalf of the service. For a second new service where the datastore type is the same as an already installed datastore, the controller logic detects whether they both are configured for sharing. If so, a second instance of the first datastore is installed for the second service and syncing between the two instances is configured.

The datastore instance configuration uses information in the config store pointed at in the custom resources and may include: the location of secrets to authenticate towards the datastore; data to be synced such as which tables; the sync frequency; overwrite settings for conflicting data; error policy; which datastore is the source of truth; as well as individual datastore settings such as indexing strategies and directory locations.

At 235, once the datastore is configured, managing of data sharing between datastores is performed. This may be configured so that the underlying Kubernetes operating platform handles syncing of data between two or more datastores or this function may be handled by the synchronisation layer 110.

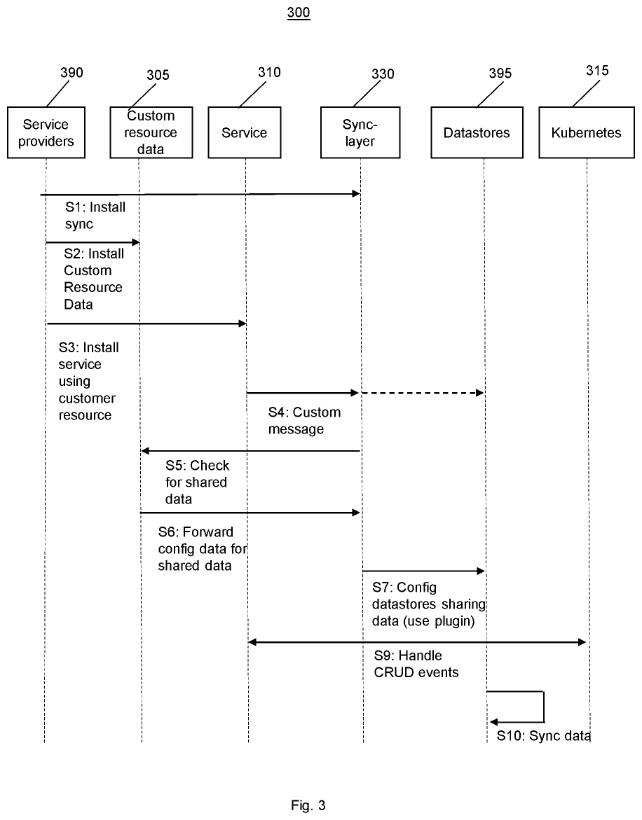

FIG. 3 illustrates a signalling diagram according to an embodiment, and which corresponds to the method of FIG. 2. The messaging involves interactions between service providers 390, custom resources 305, services 310, synchronisation layer 330, datastores 395 and the underlying Kubernetes operating platform 315.

S1 is an install sync message is sent from a service provider to the sync-layer. This may be implemented using the Service install API 185 which arranges for Kubernetes to install and configure a sync-layer for use in configuring and managing data sharing between services. Alternatively, an operator of the network may install the sync layer on top of Kubernetes.

S2 is an install custom resource data message from a provider to write a custom resource data file 305 to a config database 170. This may include an identifier to associate the custom resource with a service. In an example, the custom resource data may be stored in a config database utilising a gitops pattern. This pattern allows for the storing of potentially complex configuration data that may vary significantly across different datastores. S3 is an install service using custom resource message from a provider to a service to trigger the loaded service 310. In an example, the service is installed with a Kubernetes custom resource which points to the custom resource data in the config database 170 which enables configuring of the service. Installing the service generates custom message S4. S4 is sent to the underlying operating platform 315 but is intercepted by the sync layer 330.

The sync layer sends a message S5 to recover configuration information from the identified custom resource 305 for the service in order to install and configure a datastore for the new service. A message S5 from the config 185 includes configuration information or custom resource data from the config store and is forwarded to the sync layer 330. The sync layer uses this custom resource data to configure the datastore associated with the service. The custom resource data may refer to another datastore used by another service to enable data sharing which may result in a second instance of that datastore being installed for the new service. The sync layer may use plugins to communicate with any datastores or datastore operators which it is not natively configured for.

S9 messages represent any normal Kubernetes messages that may be transferred between the operating platform 315 and the service. Examples include create, remove and update messages S10 represents messages that may be used to sync data between datastores. These may originate from the sync-layer 330 and/or the Kubernetes platform 315.

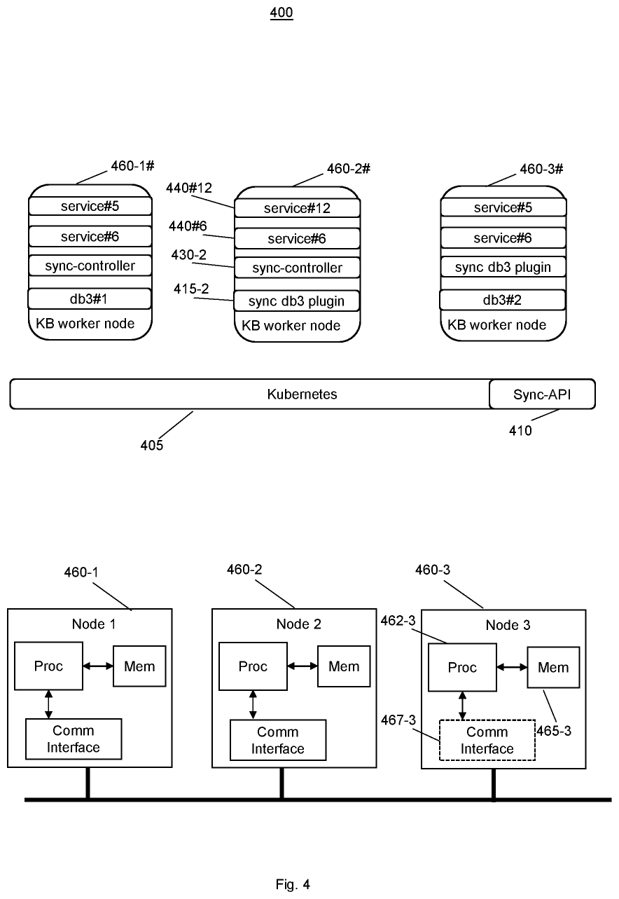

FIG. 4 illustrates a network according to an embodiment which utilises a Kubernetes operating platform 405 installed across a plurality of network nodes 460-1-460-3. Each node may comprise a processor 462-3, memory 465-3 and a communications interface 467-3 to communicate with other nodes. Each node may operate as a Kubernetes worker node or pod 460-1 #-460-3 #of containers which may include services 440 #12, 440 #6, a sync-controller 430-2 which with corresponding controllers in other pods instantiate the sync-layer. The containers may also include plugins 415-2 for use with the sync-controllers, for example to interface with datastores and/or datastore operators. The Kubernetes operating platform 405 may comprise a sync-API 410 to interface with the sync controllers 430-2.

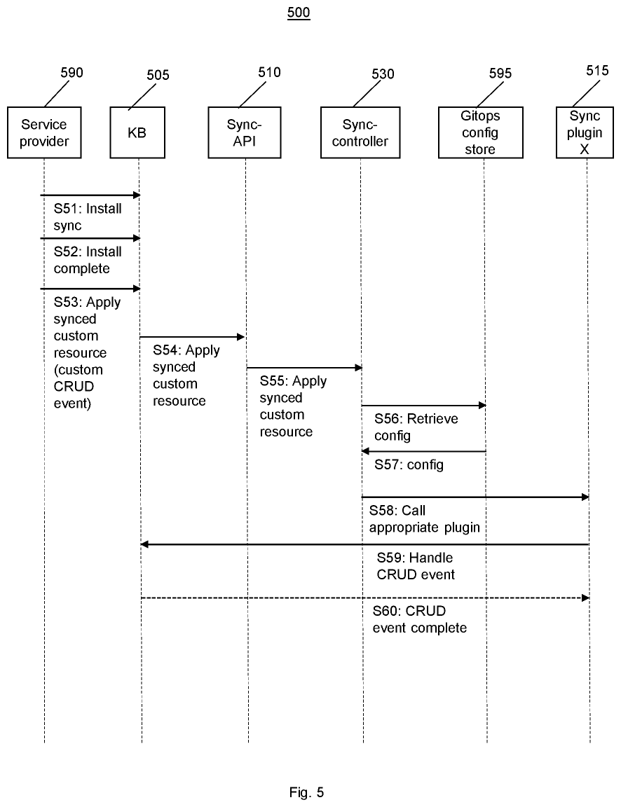

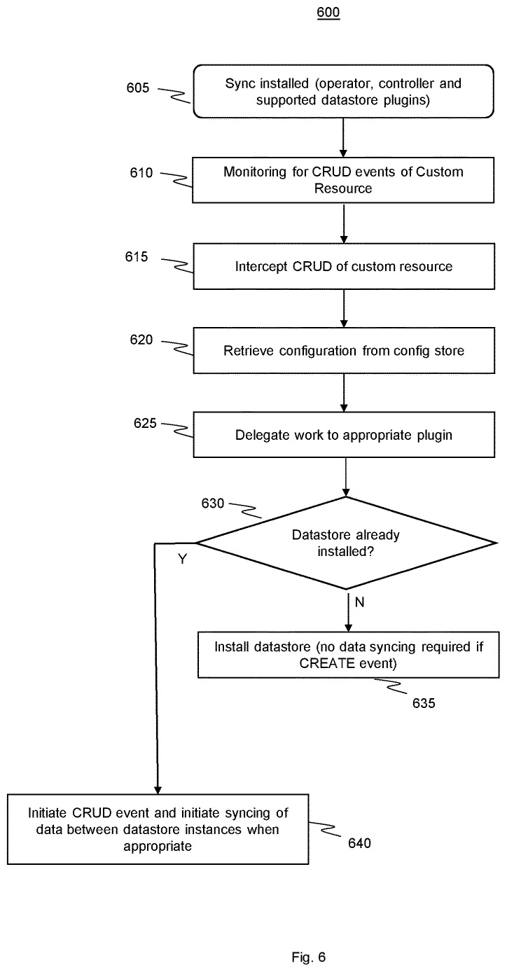

FIG. 5 illustrates a signalling diagram according to an embodiment and involves a service provider 590, a Kubernetes operating platform 505, a sync-API 510, a sync controller 540, a Gitops config store 595 and a sync plugin 515. Reference can also be made to the network architecture of FIG. 4 and the method of FIG. 6.

S51 is an install sync message from the service provider 590 to the operating platform 505 to install the sync layer. This may be implemented by instantiating the various sync controllers and plugins at respective Kubernetes worker nodes. S52 is an install complete message for when these processes are completed.

S53 is an apply synced custom resource message, such as a custom CRUD (create, read, update, delete) event that is not recognised by the underlying Kubernetes but is recognised by the sync controller. Thus, in the example the signalling of the underlying Kubernetes platform, which is normally employed for handling stateless objects, is leveraged to implement the configuration and maintenance of stateful objects such as shared databases.

S54 is a apply synced custom resource message from the operating platform to the sync-API 410 which instructs the sync-controller 430-2 on the node 460-2 #hosting the service to configure a datastore for the new service on this node.

S55 is an apply synced custom resource message from the sync-API to the sync controller of the node on which the new service is instantiated. The sync controller then sends a retrieve config message to the Gitops (git operations) config store for the custom resource for the new service. S57 is the config response message with the configuration data from the custom resource.

S58 is a call plugin message from the sync controller 530 to a plugin 515 to talk with the datastore for the new service.

S59 and S60 are messages related to CRUD events associated with the newly configured datastore which are handled by the plugin.

FIG. 6 is a method of installing and configuring a datastore of a new service for data sharing. This may be implemented by the network of FIG. 4.

At 605, the method installs the sync layer including sync controllers, datastore operators and supported plugins. At 610, the sync layer monitors for CRUD events from custom resources.

At 615, the method intercepts a custom CRUD event of a custom resource. The underlying Kubernetes platform does not recognise this and so ignores it. In the case of an Operator pattern, Kubernetes provides the ability for developers to extend their API and leverage Kubernetes signalling/looping while doing so when the native stateless or simplistic stateful objects aren't sufficient. This can be employed when dealing with stateful or persistent data. This API extension definition is called A Custom Resource Definition (CRD), and the Custom resource can be seen as a realisation of this with the controller as the software that manages it (while leveraging Kubernetes signalling/messaging loops)

At 620, the sync layer retrieves configuration data of the custom resource from the config store. At 625, the configuration work is delegated to an appropriate plugin. This may depend on the datastores associated with the new service and the service with which it will be sharing data.

At 630, the method checks if a datastore of the type specified by the configuration data is already installed and if not, the datastore is installed at 635 using a CREATE event.

If a datastore of the type specified has already been installed, a custom CRUD event is initiated to install a new instance of the already installed database and syncing of data between datastore instances is initiated and managed according to the configuration data from the custom resource.

Whilst the embodiments have been described supporting Kubernetes other operating platforms may alternatively be employed; for example Docker Swarm.

The embodiments provide a number of advantages including the ability to dynamically synchronize and share stateful data between independent datastores without any imposition on the datastore itself. This allows the individual services to honor microservices best practices and keeps failure domains small and isolated yet supports enterprise style deployments were repeated rolling out of stateful information such as user information is tedious and cumbersome. The solution imposes no requirements on service and is agnostic of deployment technology. It avoids the need to co-ordinate complicated enterprise upgrades or administrative tasks and keeps service lifecycles independent.

In some embodiments, the plugin based architecture supports incremental support for underlying datastores. Some embodiments may be agnostic of deployment technology used, such as Helm. No modification of existing deployment charts is required nor imposition of any chart structure. Applications are free to efficiently tune their datastore instance as per their requirements without concern for any shared service using it. Embodiments may simplify deployment and automate manual tasks, promote cloud native and microservice principles as well as avoid single points of failure.

Modifications and other variants of the described embodiment(s) will come to mind to one skilled in the art having the benefit of the teachings presented in the foregoing descriptions and the associated drawings. Therefore, it is understood that the embodiment(s) is/are not limited to the specific examples disclosed and that modifications and other variants are intended to be included within the scope of this disclosure. Although specific terms may be employed herein, they are used in a generic and descriptive sense only and not for purposes of limitation.

1-24. (canceled)

25. A method of data sharing for services on an operating platform for a distributed network, the method comprising:
monitoring for a first operating platform instruction corresponding to installation of a first service with a configuration resource, the first service to be associated with a first datastore;
using the configuration resource of the first service and a configuration resource of a second service to determine that the first service can share data in a second datastore associated with the second service;
in response to determining that the first service can share data in the second datastore associated with the second service, configuring the first datastore and the second datastore to share data using first and second configuration resources.

26. The method of claim 25, comprising using operating platform messaging to configure the first and second datastores.

27. The method of claim 25, comprising installing and using a plugin to communicate with the first and/or the second datastore.

28. The method of claim 25, wherein the first and second services are arranged to independently manage data in their respective first and second datastores.

29. The method of claim 25, comprising messaging the first and second datastore to synchronize the shared data.

30. The method of claim 25, comprising installing a share data module in the operating platform to perform the monitoring for a first operating platform instruction, determining that the first service can share data, and configuring the first and second datastore.

31. The method of claim 30, comprising installing a plugin to communicate between the share data module and the first and/or second datastore.

32. The method of claim 25, wherein the operating platform is Kubernetes

33. The method of claim 32, wherein the first operating platform instruction is a CRUD event.

34. The method of claim 25, comprising using an API of the operating platform to install the first configuration resource in a configuration store when installing the first service.

35. A network node for data sharing for services on an operating platform, the network node comprising a processor and memory and configured to:
monitor for a first operating platform instruction corresponding to installation of a first service with a configuration resource, the first service to be associated with a first datastore;
use the configuration resource of the first service and a configuration resource of a second service to determine that the first service can share data in a second datastore associated with the second service;
configure the first datastore and the second datastore to share data using first and second configuration resources in response to a determination that the first service can share data in the second datastore associated with the second service,

36. The network node of claim 35, configured to use operating platform messaging to configure the first and second datastores.

37. The network node of claim 35, configured to install and use a plugin to communicate with the first and/or the second datastore.

38. The network node of claim 35, configured to message the first and second datastore to synchronize the shared data.

39. The network node of claim 35, configured to install a share data module in the operating platform to perform the monitoring for a first operating platform instruction, determining that the first service can share data, and configuring the first and second datastore.

40. The network node of claim 39, configured to install a plugin to communicate between the share data module and the first and/or second datastore.

41. The network node of claim 40, wherein the first operating platform instruction is a CRUD event.

42. The network node of claim 35, configured to use an API of the operating platform to install the first configuration resource in a configuration store when installing the first service.

43. A distributed network comprising a network node according to claim 35.

44. The distributed network of claim 45, comprising the first and second datastores.
